(19) United States
(12) Patent Application Publication
(10) Pub. No.: US 2013/0251345 A1
(43) Pub. Date: Sep. 26, 2013

(54) METHOD AND DEVICE FOR STORING AND/OR REPRODUCING SOUND AND IMAGES

(71) Applicant: Pierre Olivier, Bruxelles (BE)

(72) Inventor: Pierre Olivier, Bruxelles (BE)

(21) Appl. No.: 13/699,676

(22) PCT Filed: May 25, 2011
(86) PCT No.: PCT/EP2011/058603

§ 371 Date: Jun. 3, 2013

(30) Foreign Application Priority Data
May 25, 2010 (BE) 2010/0316

(51) Int. Cl. H04N 9/79

(52) U.S. Cl. CPC H04N 9/79
USPC 386/285

(57) ABSTRACT

Method for storing sound and images in a memory, said method comprising the storage in a memory of at least one sequence comprising a first file including a digital image m (1≦m≦M) and a second file including sound relating to information linked to the digital image m concerned, said image included in the first file being displayed on a screen, and in that it is checked whether and at what moment a place j=1 (1≦j≦J) was pointed to in the displayed image and at what moment the recording of the sound is triggered, a clock being started at the moment when the recording of the sound is triggered, and in that, when it is found that the place j has been pointed to in the displayed image, the coordinates (xⱼ, yⱼ) of the place j pointed to are stored in a third file (f3ⱼ) forming part of said sequence, and in that a first time (t1ⱼ) indicated by the clock at the moment when the sound to be associated with the place j is produced is sampled, and in that a period of time (Δtⱼ) during which the production of the sound linked to the place j is or may be implemented is taken, the first time (t1ⱼ) and the period of time (Δtⱼ) being stored in a fourth file (f4ⱼ) forming part of said sequence, said storage of the sound in the second file (f2ⱼ) is implemented by storing the sound produced during said period of time (Δtⱼ).

The invention concerns a method for storing sound and images in a memory, said method comprising the storage in a memory of at least one sequence comprising a first file including a digital image m (1≦m≦M) and a second file including sound relating to information linked to the digital image m concerned, said image included in the first file being displayed on a screen, said display of the image being followed by a verification in order to determine whether a place j=1 (1≦j≦J) has been pointed to in the displayed image, and in that, when it is found that the place j has been pointed to in the displayed image, the coordinates (xⱼ, yⱼ) of the place j pointed to are stored in a third file (f3ⱼ) forming part of said sequence, the method then being repeated for any other place j≠1 pointed to in the image. The invention also concerns a method for reproducing the sound and image recorded as well as a device for applying the method.

Such a method is described in the patent U.S. Pat. No. 7,536,706. In the method described in this patent the photographs or films are for example taken by means of a digital apparatus. The photographs or films thus taken are stored in a memory, for example formed by a USB key, a DVD disc or an internet site. The user may indicate places in the image where he wishes to add sound to the image. This sound is also stored in the memory after having been recorded. When a person then wishes to see these photographs or film, the sound is produced simultaneously with the photograph or film.

Though in the case of a film the synchronization between the sound and the image can reasonably be synchronized since they are moving images and the microphone in a camera can be used, the same does not apply when it is a case of photographs to which the user wishes to add sound. Certainly the user can associate a sound with the photographs but he does not have the possibility of highlighting certain elements in the photograph by means of sound. In addition it is not obvious for the user to synchronize the sound and image, in particular if the sound is recorded separately from the image.

The aim of the invention is to produce a method for storing sound and images in a memory that enables the user to easily synchronize the sound that he wishes to add to the elements forming part of the displayed image, even if the sound and image are recorded separately.

To this end a method according to the invention is characterized in that it is also checked at what moment in time the place j was pointed to in the displayed image and at what moment the recording of the sound to be associated with the place j is triggered, a clock being started at the moment when the recording of the sound is triggered, and in that a first time (t1ⱼ) indicated by the clock at the moment when the sound to be associated with the place j is produced is sampled, and in that a period of time (Δtⱼ) during which the production of the sound linked to the place j is or may be implemented is taken, the first time (t1ⱼ) and the period of time (Δtⱼ) being stored in a fourth file (f4ⱼ) forming part of said sequence, said storage of the sound in the second file (f2ⱼ) is implemented by storing the sound produced during said period of time (Δtⱼ), and, when each of the points j pointed to in the image have been processed, said clock being stopped after the recording of the segment of sound associated with the place j=N is stopped. Starting a clock at the moment when the recording of the sound is triggered makes it possible to associate a time base with the sound that in its turn will make it possible, when the sound is reproduced, to synchronize sound and image. In addition, by sampling and storing a time t1ⱼ and a period of time (Δtⱼ) with the sound associated with a place j indicated, it is possible, at the time of reproduction, to easily find not only the link between the place j on the photograph and the sound associated with this place, but also to synchronize the sound with the place indicated. Thus the user has means where he can associate sound with certain elements of a photograph that are included on a place j indicated and reproduce the sound recorded automatically by indicating the place j. The user can thus easily synchronize the sound and the image even if the sound is recorded after the image has been taken.

A first embodiment of a method according to the invention is characterized in that said period of time (Δtⱼ) is a predetermined period of time. This makes it possible to easily determine this period of time and thus mange the quantity of memory available for storing sound.

A second embodiment of a method according to the invention is characterized in that said period of time (Δtⱼ) is determined by the moment when the production of the sound at the place j is stopped. This makes it possible to choose a variable time for the period of time.

A third embodiment of the method according to the invention is characterized in that said period of time (Δtⱼ) is determined by the moment when the next place j+1 is pointed to in the image. This makes it possible to choose a variable time for the period of time while having an automatic determination of this period of time (Δtⱼ).

A fourth embodiment of a method according to the invention is characterized in that, when the sound to be associated with any one of the places j is recorded, it is checked whether a pause is produced in the production of said sound, and in that, if such a pause is produced, a second time (t2ⱼ) indicated by the clock at the moment when the pause occurs and a third time indicated by the clock at the moment when the pause stops are stored in the fourth file (f4ⱼ). Thus it is possible also to reproduce pauses left by whoever produces the sound during recording thereof, without for all that having to consume memory space.

A fifth embodiment of the method according to the invention is characterized in that, when sound to be associated with one of the places j is recorded, it is checked whether, during said pause, an action is undertaken, and in that, if it is found that an action is undertaken, this action is identified and stored in the fourth file. Such an action may for example be a zoom on the place j in question. By storing the action it is possible reproduce it subsequently.

A sixth embodiment of the method according to the invention is characterized in that, when a place j is pointed to in the image displayed, an identifier is associated with this image and displayed at the place j pointed to. The association of an identifier with the place j pointed to makes it possible to recognize it more easily when the image is subsequently reproduced and thus facilitates the selection of the place by the user.

According to the invention, the method for displaying the stored image and reproducing the sound recorded is characterized in that at least one of the M images stored is reproduced on the screen so as to enable a user to choose an image m among the M images stored, and in that the sequence associated with the image m chosen is taken from the memory and said N places associated with the image m chosen being displayed after selection of the image m stored, and in that, after selection of a place j, the second, third and fourth files associated with said place j are read and the sound associated with this place j is produced from the second file that has just been read, starting the sound at the first time and stopping the sound when the period of time has elapsed. Use of the sequence recorded makes it possible to easily reconstruct the sound associated with the place j indicated and to synchronize it with the image.

The invention will now be described in more detail with the help of the drawings, which illustrate a preferential embodiment of the method and device according to the invention.

In the drawings:

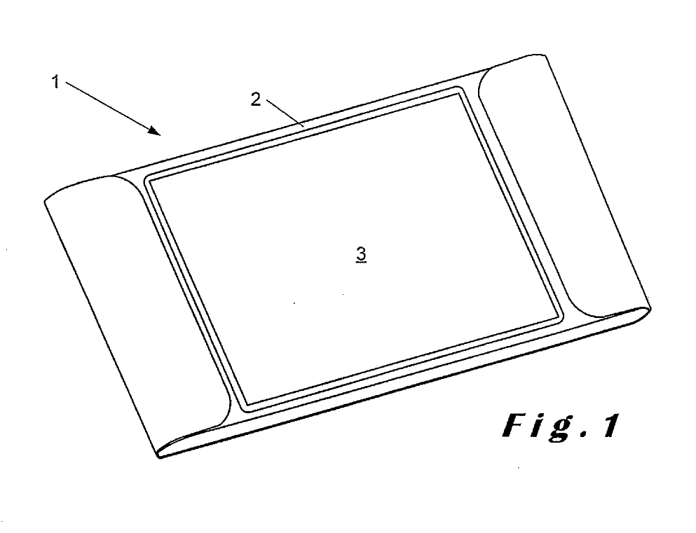

FIG. 1 shows an overall view of an example of a device according to the invention;

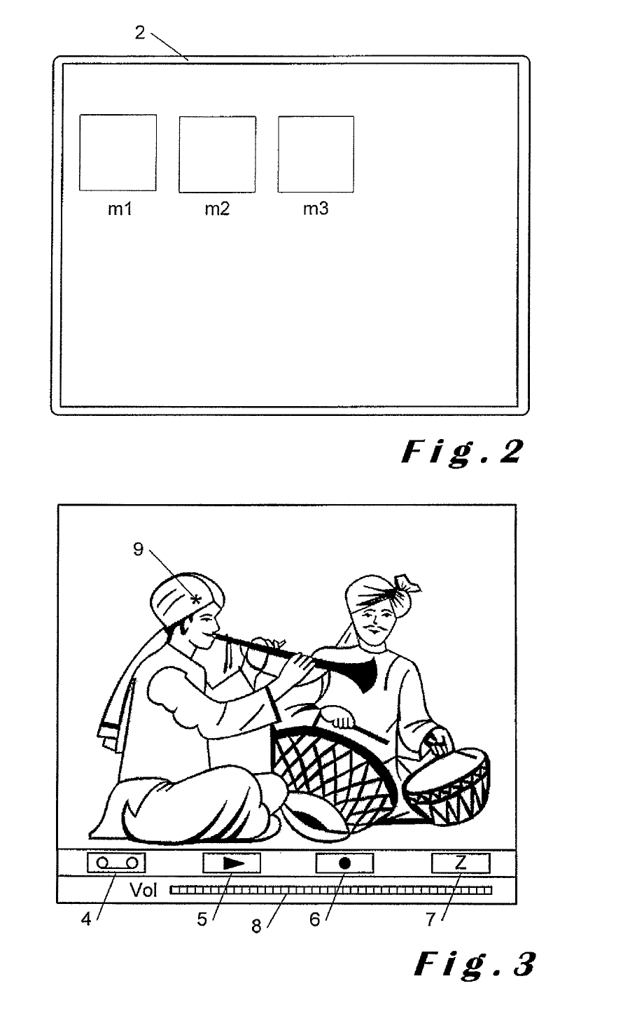

FIG. 2 shows the same device with a few images displayed on the screen of the device according to the invention;

FIG. 3 illustrates the screen during the application of the sound storage method;

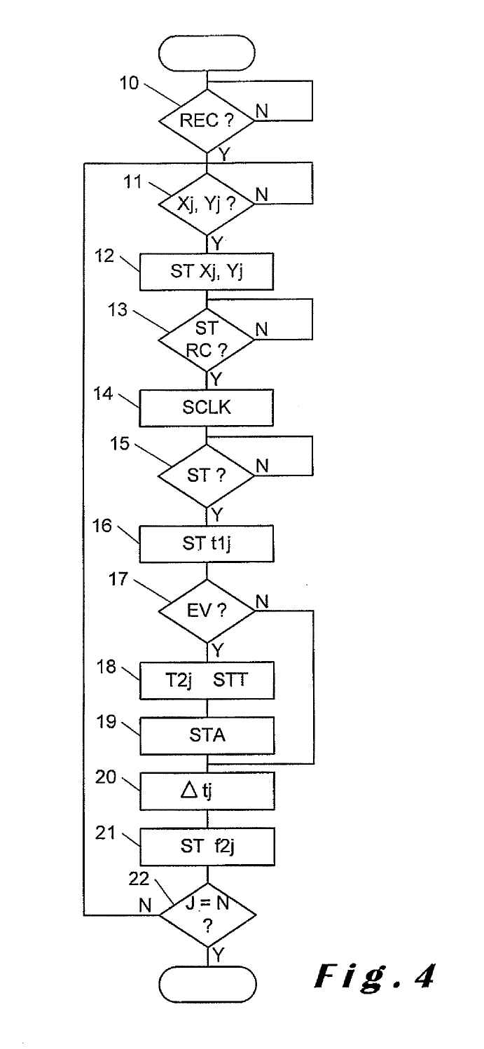

FIG. 4 illustrates, by means of a flow diagram, the steps of the sound storage method;

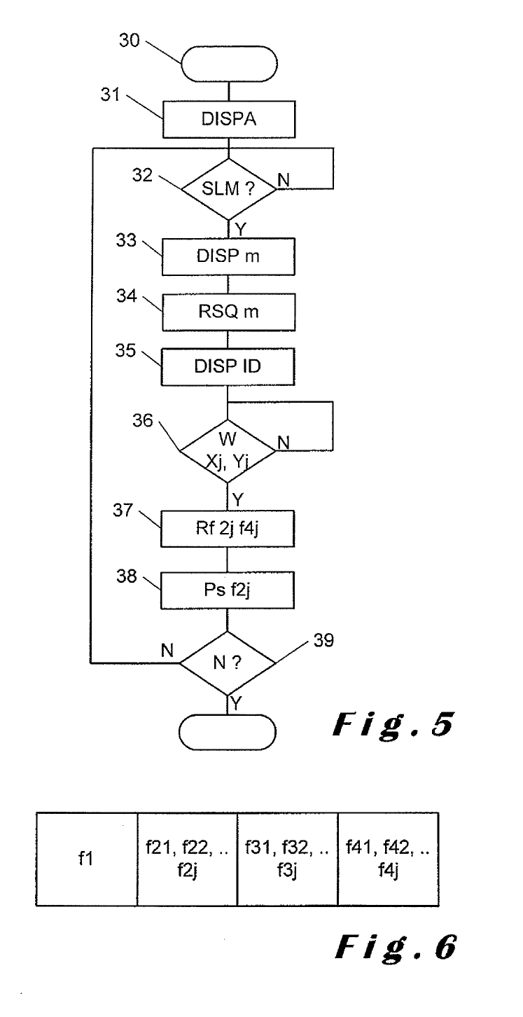

FIG. 5 illustrates, by means of a flow diagram, the steps of the sound storage method;

FIG. 6 illustrates an example of a sequence formed during the application of the sound storage method.

In the drawings the same reference has been allocated to the same element or to a similar element.

FIG. 1 shows an overall view of an example of a device 1 according to the invention. The device comprises a frame 2 surrounding a screen 3. The screen 3 may be a touch screen, which has the advantage of being able to display the operating buttons of the device on the screen. However, it will be clear that the screen does not necessarily need to be a touch screen and that other types of screen may be used. If the screen is not of the touch type, control buttons (not included in the drawings) are mounted on this frame so as to make it possible to control the device by means of these. It is also possible to use a voice command to control the various functions of the device. It should also be noted that the device according to the invention is not necessarily formed by an entity having the sole function of displaying images and reproducing sound. The device according to the invention may also be integrated in a computer or a telephone provided with a memory and a data processor.

The device according to the invention comprises a memory and a data processor, preferably formed by a microprocessor. The memory may for example be formed by a semiconductor memory such as a USB key, an optical disc or any other type of memory accessible electronically. The memory must be of the type to be able to write data therein and preferably also to enable data to be deleted.

Images are stored in the memory, preferably those taken by a user by means of a digital photographic apparatus. However, it goes without saying that it is also possible to store downloaded images in the memory. The storage of the images in the memory is done in a well known manner and will not be described in further detail. It should however be noted that, according to the invention, the storage of each image is done by storing, for each image to be stored, a sequence comprising a first file f₁ including the digital image, as illustrated in FIG. 6.

When the user has stored one or more images, either in the form of individual images or in the form of a video, in the memory, he can display one or more images on the screen 3 of the device 1. FIG. 2 illustrates an example of a series of M (1≦m≦M) individual images (m=1, m=2, m=3) displayed on the screen 2. This way of displaying enables the user to have an idea of the images stored and thus facilitates for him the choice of one of the images stored. However, once again, it will be clear that this is only one way among others of displaying the stored images and that other ways, such as scrolling the images, can also be used. It is however necessary for the device to have selection means to enable the user to choose one or more images from those stored in the memory since this is necessary for choosing the image m to which it is necessary to add sound.

When the user has chosen one of the stored images, for example the one illustrated in FIG. 3, he or she can start the method according to the invention. This may for example be implemented either by actuating a button displayed on the screen or by actuating a button on the device. After having actuated this button, another series of buttons will be made activatable, for example by display on the screen if a touch screen is used, as illustrated in FIG. 3. This other series of buttons comprises for example a button 5 for triggering and stopping the recording of the sound, a button 6 for marking a pause in the recording of the sound and a button 7 to enable a zoom. Preferably, a frame 4 is also displayed to mark the time elapsed since the start of the recording of the sound and a frame 8 that indicates the volume of the sound recorded. Naturally other buttons, such as a curser manipulation button, can also be displayed on the screen.

FIG. 4 illustrates, by means of a flow diagram, the method for storing sound according to the invention. After the user has actuated (10, REC ?) the button 5 indicating that he or she wished to record sound to be associated with image m that he or she has chosen, it is checked (11, xⱼ, yⱼ ?) whether the user is pointing to a place xⱼ, yⱼ (1≦j≦N) in the image m. This enables the user to choose in the image m displayed the place j on which there is displayed a subject with regard to which he or she wishes to give a commentary. The method enables the user to choose a number N of places to be pointed to in the image. This number may vary according to the capacity of the memory and the size of the screen.

After the user has pointed to a place j in the image, the coordinates (xⱼ, yⱼ) of the place j pointed to are stored (12, ST xⱼ, yⱼ) in a third file f3ⱼ (see FIG. 6) forming part of the sequence l linked to the image m. Preferably, when a place j is pointed to in the image m displayed, an identifier 9 is associated with this image and is displayed at the place j pointed to (see FIG. 3). This enables the user to recognise not only, when sound is being recorded, the place j pointed to, but also makes it possible, during a subsequent display, to recognise the places in the image with which a sound has been associated. This identifier may for example be a star, a triangle, a particular colour such as a small red ball, or finally any identifier that makes it possible to distinguish the points j pointed to in the image.

Next it is checked (13; STRC ?) at what moment the recording of the sound is triggered, for example by touching the button 6, in order to start a clock (14; SCLK). Next it is checked (15; ST SP) at which moment the sound to be associated with the place j is produced and, when it is found that this sound has begun, a first time t1ⱼ, indicated by the clock at the moment when the sound to be associated with the place j begins to be produced, is taken from the clock and stored (16; STt1ⱼ) in a temporary memory.

It is then checked whether an event occurs (17; EV ?) during the sampling of the sound. Such an event may be the fact that the production of the sound stops, for example because the user has pressed on the button 7 in order to zoom, or that the user marks a pause by activating the button 6, or undertakes another action such as changing the color. Whenever such an event occurs, the time tkⱼ indicated by the clock at the moment when the event occurs is sampled (18, tkⱼ). Thus, when the production of the sound is stopped in order to mark a pause, a second time t2ⱼ is sampled. A third time t3ⱼ is sampled when the pause has ended. The second and third times are stored temporarily (18; STT). When an action is undertaken preferably a fourth time t4ⱼ is sampled and the action is identified. The time t4ⱼ and the action identified are then stored (19; STA) temporarily.

The period of time Δtⱼ during which the production of the sound linked to the place j is or may be effected is included (20; Δtⱼ). This may be done by predetermining a period of time of for example 3 seconds per place pointed to. According to another embodiment the period of time Δtⱼ is determined by the moment when the production of the sound linked to the place j is stopped, for example because the user actuates the button 5 or because the method itself detects the stoppage of the sound. Finally, the period of time Δtⱼ may also be determined by the moment when the next place j+1 is pointed to in the image m. In these last two embodiments, the time t_{f} indicated by the clock is sampled and the period Δtⱼ is determined by the difference in time between t_{f} and t₁. The period of time Δtⱼ and the time t1ⱼ are stored in a fourth file forming part of the sequence.

The sound produced during the period of time Δtⱼ is stored (21; STf2ⱼ) in the second file. The sequence is thus completed by adding thereto the second, third and fourth files. The sequence thus completed is stored in the memory. It is then checked (22, j=N ?) whether other places are indicated and, if such is the case, the method resumes for the other places pointed to until each of the N places pointed to has been processed. If an action has been identified, the identifier of this action is stored in the fourth file. The clock is stopped (23; STCLK) at the moment when all the points N have been processed. Preferably, the total time of the sound to be recorded for the N images is limited in order not saturate the memory with sound. FIG. 5 illustrates the method according to the invention which makes it possible to display a stored image and to reproduce the sound recorded with the image chosen. When a user wishes to use the device according to the invention to see the recorded images, he will activate a vision program. This is for example done by touching (30, FIG. 5) a button displayed on the screen or a fixed button on the device itself. After the activation of said button, one or more of the images stored in the memory will be displayed (31; DISPA) to enable the user to make a selection among the images displayed.

The device waits (32; SLM ?) until the user has chosen an image from those stored in the memory. After the user has made his choice of an image, let us assume the image m among the M images stored, this image m is displayed (33; DISPm) on the screen. The sequence linked to this image m is also sampled (34; RSQm). If the application comprises indicators 9, the latter are positioned (35; DISP ID) at each of the N places in the image displayed for which coordinates (xⱼ, yⱼ) are stored in the third file (f3ⱼ) of the sampled sequence.

The application waits (36; wxⱼ, yⱼ ?) while a place (xⱼ, yⱼ) is chosen in the displayed image. After selection of a place (xⱼ, yⱼ) the second and fourth files linked to the place (xⱼ, yⱼ) present in the first file are read (37; R f2ⱼ, f4ⱼ) and the sound stored in the second file is produced and presented to the user (38; Psf2ⱼ). To this end, the production of the sound is controlled by the times t1ⱼ and t2ⱼ stored in the fourth file, which allows synchronization between the image and the sound. Where applicable by the other times to allow pauses or actions.

After the production of the sound the application checks whether another place is chosen (39, N ?) and, if such is the case, the method is resumed from the step marked 33. If any other place is chosen, the method stops.

1. Method for storing sound and images in a memory, said method comprising the storage in a memory of at least one sequence comprising a first file including a digital image m (1≦m≦M) and a second file including sound relating to information linked to the digital image m concerned, said image included in the first file being displayed on a screen, said display of the image being followed by a verification in order to determine whether a place j=1 (1≦j≦J) has been pointed to in the displayed image, and in that, when it is found that the place j has been pointed to in the displayed image, the coordinates (xⱼ, yⱼ) of the place j pointed to are stored in a third file (f3ⱼ) forming part of said sequence, the method then being repeated for any other place j≠1 pointed to in the image, characterized in that it is also checked at what moment in time the place j was pointed to in the displayed image and at what moment the recording of the sound to be associated with the place j is triggered, a clock being started at the moment when the recording of the sound is triggered, and in that a first time (t1ⱼ) indicated by the clock at the moment when the sound to be associated with the place j is produced is sampled, and in that a period of time (Δtⱼ) during which the production of the sound linked to the place j is or may be implemented is taken, the first time (t1ⱼ) and the period of time (Δtⱼ) being stored in a fourth file (f4ⱼ) forming part of said sequence, said storage of the sound in the second file (f2ⱼ) is implemented by storing the sound produced during said period of time (Δtⱼ), and, when each of the points j pointed to in the image have been processed, said clock being stopped after the recording of the segment of sound associated with the place j=N is stopped.

2. Method according to claim 1, characterized in that said period of time (Δtⱼ) is a predetermined period of time.

3. Method according to claim 1, characterized in that said period of time (Δtⱼ) is determined by the moment when the production of the sound linked to the place j is stopped.

4. Method according to claim 1, characterized in that said period of time (Δtⱼ) is determined by the moment when a next place j+1 is pointed to in the image

5. Method according to claim 1, characterised in that, during the recording of the sound to be associated with any one of the places j, it is checked whether a pause is produced in the production of said sound, and in that, if such a pause is produced, a second time (t2ⱼ) indicated by the clock at the moment when the pause occurs and a third time (t3ⱼ) indicated by the clock at the moment when the pause stops is stored in the fourth file (f4ⱼ).

6. Method according to claim 5, characterised in that, during the recording of the sound to be associated with any one of the places j, it is checked whether, during said pause, an action is undertaken, and in that, if it is found that an action is undertaken, this action is identified and stored in the fourth file (f4ⱼ).

7. Method according to claim 1, characterized in that, when a place j is pointed to in the image displayed, an identifier is associated with this image and displayed at the place j pointed to.

8. Method for displaying a stored image and for reproducing recorded sound by applying the method according to claim 1, characterized in that at least one of the M images stored is reproduced on the screen so as to enable a user to choose an image m among the M images stored, and in that the sequence associated with the image m chosen is taken from the memory and said N places associated with the image m chosen being displayed after selection of the image m stored, and in that, after selection of a place j, the second, third and fourth files associated with said place j are read and the sound associated with this place j is produced from the second file that has just been read, starting the sound at the first time and stopping the sound when the period of time (Δtⱼ) has elapsed.

9. Method for displaying a stored image and for reproducing recorded sound by applying the method according to claim 5, characterized in that at least one of the M images stored is reproduced on the screen so as to enable a user to choose an image m among the M images stored, and in that the sequence associated with the image m chosen is taken from the memory and said N places associated with the image m chosen being displayed after selection of the image m stored, and in that, after selection of a place j, the second, third and fourth files associated with said place j are read and the sound associated with this place j is produced from the second file that has just been read, starting the sound at the first time and stopping the sound when the period of time (Δt₁) has elapsed, and characterized in that, when the fourth file associated with the chosen place j indicates a pause and/or an action, this pause is included in the sound produced and/or this action is included in the image m chosen and displayed on the screen.

10. Device for implementing the method according to claim 1, characterized in that it comprises a memory arranged to store therein at least one of said M images in said first file and in said second file sound associated with said at least one image as well as said third and fourth files, said memory being connected to selection means associated so as to choose an image m among those stored, said device also comprising a clock and means for sampling said first time indicated by said clock as well as said period of time (Δtⱼ), said device comprising selection means for choosing an image from said M images and a place xᵢ, yⱼ in the image m chosen.
